(19) United States
(12) Patent Application Publication
(10) Pub. No.: US 2013/0173954 A1
(43) Pub. Date: Jul. 4, 2013

(54) METHOD OF MANAGING BAD STORAGE REGION OF MEMORY DEVICE AND STORAGE DEVICE USING THE METHOD

(71) Applicant: Samsung Electronics Co., Ltd., Suwon-Si (KR)

(72) Inventors: Yeong-jae WOO, Suwon-si (KR); Dong-gi LEE, Yongin-si (KR); Dong-hyun SONG, Hwaseong-si (KR); Jin-hyuk LEE, Seoul (KR)

(73) Assignee: SAMSUNG ELECTRONICS CO., LTD., Suwon-Si (KR)

(21) Appl. No.: 13/713,378

(22) Filed: Dec. 13, 2012

(30) Foreign Application Priority Data
Jan. 2, 2012 (KR) 10-2012-0000173

(51) Int. Cl. G06F 11/16

(52) U.S. Cl. CPC G06F 11/167
USPC 714/6.13

(57) ABSTRACT

A method of managing a bad storage region of a memory device may include detecting a bad page of a selected data block that has failed in one of a program operation, a read operation, and an erase operation on the memory device; and performing a mapping process so that the detected bad page is excluded from a storage region to which data is to be programmed, wherein remaining pages of the selected data block excluding the bad page are allowed to be used as a storage region in a garbage collection operation.

### CROSS-REFERENCE TO RELATED APPLICATIONS

This application claims priority under 35 U.S.C. §119 to Korean Patent Application No. 10-2012-0000173, filed on Jan. 2, 2012, in the Korean Intellectual Property Office (KIPO), is the entire contents of which are incorporated herein in its entirety by reference.

### BACKGROUND

1. Field

Example embodiments of the inventive concepts relate to storage devices, and more particularly, to a method of managing a bad storage region of a memory device and a storage device using the method.

2. Related Art

A non-volatile memory device is a memory device capable of retaining stored information even when power is off. An example of the non-volatile memory device is flash memory. A part of a storage region of a non-volatile memory device may be bad. When a bad storage region exists, the size of a storage region useable in a non-volatile memory device is reduced. Accordingly, research into technology for managing bad storage regions may be desirable.

### SUMMARY

Example embodiments of the inventive concepts provide a method of managing a bad storage region of a memory device to increase the lifespan of a storage device.

Example embodiments of the inventive concepts also provide a storage device for managing a bad storage region of a memory device to increase the lifespan of the storage device.

According to example embodiments of the inventive concepts, a method of managing a bad storage region of a memory device may include detecting a bad page of a selected data block that has failed in one of a program operation, a read operation, and an erase operation on the memory device; and performing a mapping process so that the detected bad page is excluded from a storage region to which data is to be programmed, wherein remaining pages of the selected data block excluding the bad page are allowed to be used as a storage region in a garbage collection operation.

The performing of the mapping process may comprise registering the bad page in bad page list information and excluding pages registered in the bad page list information from a storage region to which data is to be stored.

The performing of the mapping process with respect to a bad page detected in the program operation may comprise registering storage region information regarding the bad page in the bad page list information; and allocating a physical address for a logical address so that data supposed to be programmed into the bad page is programmed into a page not registered in the bad page list information.

When an empty page not registered in the bad page list information exists in a block including the bad page, a physical address may be allocated for a logical address so that the data supposed to be programmed into the bad page is programmed into one of empty pages of the block, and, when no empty pages exist in the block including the bad page, a physical address may be allocated for a logical address so that the data supposed to be programmed into the bad page is programmed into one of pages included in a new free block.

The storage region information may be represented by a physical page number.

The method may further comprise determining the memory device to be bad when the number of bad pages registered in the bad page list information exceeds an initially set threshold value.

When all of pages included in a block to which data is to be programmed are detected as bad pages in the program operation, mapping may be performed so that the block to which data is to be programmed is replaced with a new free block.

When all of pages included in a block to which data is to be programmed are detected as bad pages in the program operation, mapping may be performed so that the block to which data is to be programmed is replaced with a reserved block.

The performing of the mapping process with respect to a bad page detected in the read operation may comprise registering storage region information regarding the bad page into the bad page list information; and performing a mapping process so that the bad page is not reused as a storage region in a garbage collection operation.

The method may further comprise determining the memory device to be bad when the number of bad pages registered in the bad page list information exceeds an initially set threshold value.

When all of pages included in a block from which data is to be read are detected as bad pages in the read operation, mapping may be performed so that the block from which data is to be read is replaced with a reserved block.

When all of pages included in a block from which data is to be read are detected as bad pages in the read operation, mapping may be performed so that the block from which data is to be read is replaced with a new free block.

According to example embodiments of the inventive concepts, a storage device may include a memory device configured to store data; and a memory controller configured to perform mapping so that a bad page of a selected data block for which a program fail, a read fail, or an erase fail occurred in the memory device is excluded from a storage region to which data is to be programmed, and so that remaining pages of the selected data block excluding the bad page are reused as the storage region in a garbage collection operation.

The memory device may comprise an array of memory cells which comprises a plurality of pages; a page buffer circuit which programs the memory cells or reads data from the memory cells; a verifying circuit which performs program verification or erase verification on the memory cells in response to program data received from the page buffer circuit; and a control circuit which controls a program operation or an erase operation based on a result of the program verification or a result of the erase verification.

The memory controller may comprise a volatile memory unit which temporarily stores mapping table information and bad page list information; and a control unit which performs mapping so that a bad page including a program fail, a read fail, or an erase fail in the memory device is registered in the bad page list information, that pages registered in the bad page list information are excluded from pages which are to be mapped to logical addresses designated by a program command, and pages not registered in the bad page list information from a data block are reused as the storage region in a garbage collection operation.

According to example embodiments of the inventive concepts a method of managing a memory device ay include an identification operation including identifying one or more bad pages for which a failed memory access operation occurred in the memory device from among a plurality of pages of a data block; and an allocation operation including allocating space within the data block by designating only data pages, from among the plurality of data pages, which have not been identified as one of the one or more bad pages as free pages available to store data.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of a data storage system according to example embodiments of the inventive concepts;

FIG. 2 is a detailed block diagram of a host device illustrated in FIG. 1;

FIG. 3 is a detailed block diagram of a memory controller illustrated in FIG. 1;

FIG. 4 is a structural view of an information storage region of a memory device illustrated in FIG. 1;

FIG. 5 is a detailed structural view of flash memory as an example of the memory device illustrated in FIG. 1;

FIG. 6 is a conceptual view showing an internal storage structure of the flash memory illustrated in FIG. 8;

FIG. 7 is a diagram showing a logical hierarchical structure of software of the data storage system illustrated in FIG. 1;

FIG. 8A is a block diagram for showing an address translation process in a flash translation layer (FTL) in response to a data write request according to example embodiments of the inventive concepts;

FIG. 8B illustrates a mapping table obtained after performing the address translation process of FIG. 8A;

FIG. 8C is a view of bad page list information obtained after performing the address translation process of FIG. 8A;

FIG. 9A is a block diagram for showing an address translation process in a FTL in response to a data write request according to another embodiment of the inventive concept;

FIG. 9B illustrates a mapping table obtained after performing the address translation process of FIG. 9A;

FIG. 9C is a view of bad page list information obtained after performing the address translation process of FIG. 9A;

FIG. 10A is a block diagram for showing an address translation process in a FTL in response to a data read request according to another embodiment of the inventive concept;

FIG. 10B illustrates a mapping table which is used in the address translation process of FIG. 10A;

FIG. 10C is a view of bad page list information obtained after performing the address translation process of FIG. 10A;

FIG. 10D is a view of a sector structure for a physical page number obtained after performing the address translation process of FIG. 10A;

FIG. 11 is a diagram for showing a mapping flow according to a method of managing a bad storage region of a memory device according to example embodiments of the inventive concepts;

FIG. 12 is a diagram for showing a mapping flow according to a method of managing bad storage region of a memory device according to another embodiment of the inventive concept;

FIG. 13 is a flowchart of a method of managing a bad storage region of a memory device according to example embodiments of the inventive concepts;

FIG. 14 is a flowchart of a garbage collection method according to example embodiments of the inventive concepts;

FIG. 15 is a flowchart of a method of managing a bad storage region of a memory device according to another embodiment of the inventive concept;

FIG. 16 is a flowchart of a method of managing a bad storage region of a memory device according to another embodiment of the inventive concept;

FIG. 17 is a block diagram of a computer system according to example embodiments of the inventive concepts;

FIG. 18 is a block diagram of a memory card according to example embodiments of the inventive concepts; and

FIG. 19 is a block diagram of a network system including a data storage system according to example embodiments of the inventive concepts.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

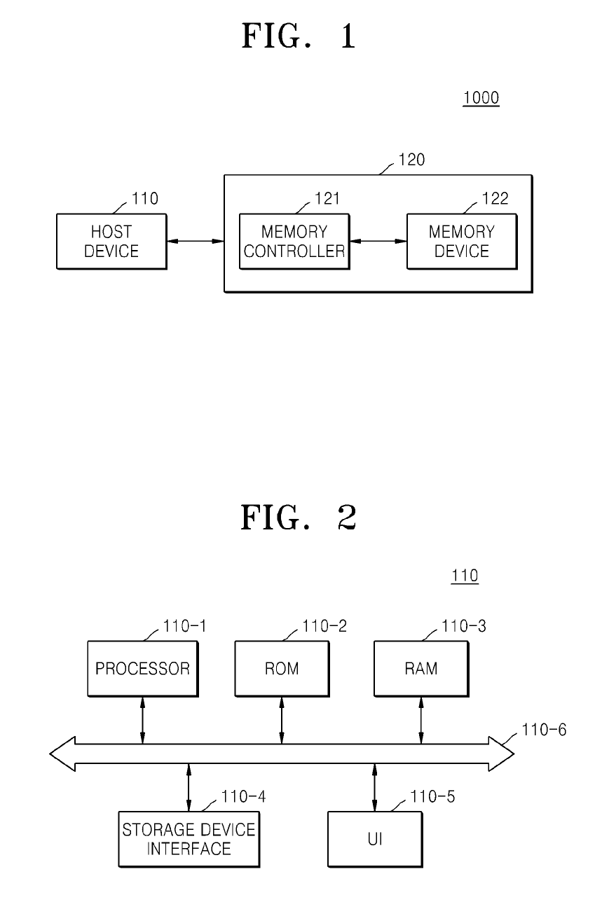

FIG. 1 is a block diagram of a data storage system 1000 according to example embodiments of the inventive concepts.

As illustrated in FIG. 1, the data storage system 1000 includes a host device 110 and a storage device 120.

FIG. 2 is a detailed block diagram of the host device 110 illustrated in FIG. 1.

As illustrated in FIG. 2, the host device 110 includes a processor 110-1, a read only memory (ROM) 110-2, a random access memory (RAM) 110-3, a storage device interface 110-4, a user interface (UI) 110-5, and a bus 110-6.

The bus 110-6 may refer to a transmission channel via which data is transmitted between the other components of the host device 110.

The ROM 110-2 may store various application programs. For example, application programs supporting storage protocols such as Advanced Technology Attachment (ATA), Small Computer System Interface (SCSI), embedded Multi Media Card (eMMC), and Unix File System (UFS) protocols are stored.

The RAM 110-3 may temporarily store data or programs.

The UI 110-5 may be a physical or virtual medium for exchanging information between a user and the host device 110, a computer program, etc., and includes physical hardware and logical software. For example, the UI 110-5 may include an input device for allowing the user to manipulate the host device 110, and an output device for outputting a result of processing an input of the user.

The processor 110-1 may control overall operations of the host device 110. The processor 110-1 may generate a command for storing data in the storage device 120 or a command for reading data from the storage device 120 by using an application stored in the ROM 110-2, and transmit the command to the storage device 120 via the storage device interface 110-4.

The storage device interface 110-4 may include an interface supporting a storage protocol, e.g., an Advanced Technology Attachment (ATA) interface, a Serial Advanced Technology Attachment (SATA) interface, a Parallel Advanced Technology Attachment (PATA) interface, a Universal Serial Bus (USB) or Serial Attached Small Computer System (SAS) interface, a Small Computer System Interface (SCSI), an embedded Multi Media Card (eMMC) interface, or a Unix File System (UFS) interface.

Referring back to FIG. 1, the storage device 120 may include a memory controller 121 and a memory device 122.

The case where the memory device 122 is implemented using flash memory which is a non-volatile memory will now be described. However, memory used to implement the memory device 122 is not limited to flash memory, and various kinds and types of memory may be used. For example, the memory used in the memory device 122 may be not only flash memory but also phase change RAM (PRAM), ferroelectric RAM (FRAM), magnetic RAM (MRAM), or the like. The memory device 122 may be implemented as a combination of at least one non-volatile memory and at least one volatile memory or as a combination of at least two types of non-volatile memory.

For example, if the memory device 122 may be implemented using non-volatile semiconductor memory such as flash memory, the storage device 120 may be a solid state drive (SSD).

The memory controller 121 may control an erase, write, or read operation in the memory device 122 in response to a command received from the host device 110.

FIG. 3 is a detailed block diagram of the memory controller 121 illustrated in FIG. 1.

As shown in FIG. 3, the memory controller 121 may include a host interface 121-1, a RAM 121-2, a control unit 121-3, an error correction code (ECC) processing unit 121-4, a memory interface 121-5, and a bus 121-6.

For example, the control unit 121-3 and the ECC processing unit 121-4 may be integrally formed into a single chip. Alternatively, the host interface 121-1, the RAM 121-2, the control unit 121-3, the ECC processing unit 121-4, and the memory interface 121-5 may be integrally formed into a single chip.

The bus 121-6 may refer to a transmission channel via which data is transmitted between other components of the memory controller 121.

The control unit 121-3 may control overall operations of the storage device 120. In more detail, the control unit 121-3 may read a command received from the host device 110, and control the storage device 120 to perform an operation according to a result of reading the command.

The host interface 121-1 may include a protocol for exchanging data with the host device 110 that accesses the storage device 120, and connect the storage device 120 and the host device 110 to each other. The host interface 121-1 may be implemented using, but not limited to, an Advanced Technology Attachment (ATA) interface, a Serial Advanced Technology Attachment (SATA) interface, a Parallel Advanced Technology Attachment (PATA) interface, a Universal Serial Bus (USB) or Serial Attached Small Computer System (SAS) interface, a Small Computer System Interface (SCSI), an embedded Multi Media Card (eMMC) interface, or a Unix File System (UFS) interface. In more detail, the host interface 121-1 may exchange commands, addresses, and data with the host device 110 by the control of the control unit 121-3.

The RAM 121-2 may temporarily stores data transmitted from the host device 110, data generated by the control unit 121-3, and data read from the memory device 122. The RAM 121-2 may also stores metadata read from the memory device 122. The RAM 121-2 may be implemented using, for example, DRAM or SRAM.

The metadata may be data generated by the storage device 120 in order to manage the memory device 122. The metadata, which is management information, may include mapping table information 121-2a used to translate a logical address into a physical address of the memory device 122. For example, the mapping table information 121-2a may include information necessary for mapping a logical address to a physical address in units of pages. The metadata may further include bad page list information 121-2b in which information regarding bad pages detected from the memory device 122 is registered. The bad page list information 121-2b may be separated from the metadata and stored. The metadata may also include a plurality of pieces of information used to manage the storage space of the memory device 122.

The ECC processing unit 121-4 may generate an error correction code (ECC) for data which is received using an algorithm such as a Reed-Solomon (RS) code, a Hamming code, or a cyclic redundancy code (CRC) during a write operation. During a read operation, the ECC processing unit 121-4 may perform error detection and error correction on received data by using the ECC read together with the data.

An error correction capability for each unit size of the ECC processing unit 121-4 may depend on an ECC size. For example, if an ECC algorithm for processing bit errors of up to 16 bits in 1024-byte data may require an ECC size of 112 bytes per 4K byte page, an ECC algorithm for processing bit errors of up to 32 bits in 1024-byte data requires an ECC size of 224 bytes per 4K byte page.

The ECC processing unit 121-4 may be unable to perform error correction when an error exceeding the error correction capability is detected. According to example embodiments of the inventive concepts, the ECC processing unit 121-4 may output a signal informing a read fail to the control unit 121-3.

The memory interface 121-5 may be electrically connected to the memory device 122. The memory interface 121-5 may exchange commands, addresses, and data with the memory device 122 by the control of the control unit 121-3. The memory interface 121-5 may be formed to support NAND flash memory or NOR flash memory. The memory interface 121-5 may be formed to selectively perform software and hardware interleaving operations via a plurality of channels.

The control unit 121-3 may provide a read command and an address to the memory device 122 in a read operation, and provide a write command, an address, and data to the memory device 122 in a write operation. The control unit 121-3 may translate a logical address received from the host device 110 into a physical address by using the metadata stored in the RAM 121-2.

If power is supplied to the storage device 120, the control unit 121-3 may read the metadata stored in the memory device 122 and control the storage device 120 to store the metadata in the RAM 121-2. The control unit 121-3 may control the storage device 120 to update the metadata stored in the RAM 121-2 according to an operation of changing the metadata in the memory device 122. The control unit 121-3 may also control the storage device 120 to write the updated metadata stored in the RAM 121-2 into the memory device 122 before the power supplied to the storage device 120 is cut off.

The control unit 121-3 may perform a process of registering bad pages which have experienced a program fail, a read fail, or an erase fail in the memory device 122 into the bad page list information 121-2b stored in the RAM 121-2. The control unit 121-3 may also perform a mapping process so that the pages registered in the bad page list information 121-2b are excluded from pages which are to be mapped to logical addresses designated by a program command and so that pages not registered in the bad page list information 121-2b from a data block are reused as a storage region in a garbage collection operation.

The control unit 121-3 may include firmware built therein for performing an operation such as bad region management for a memory device to be described later, the mapping process, or the garbage collection operation.

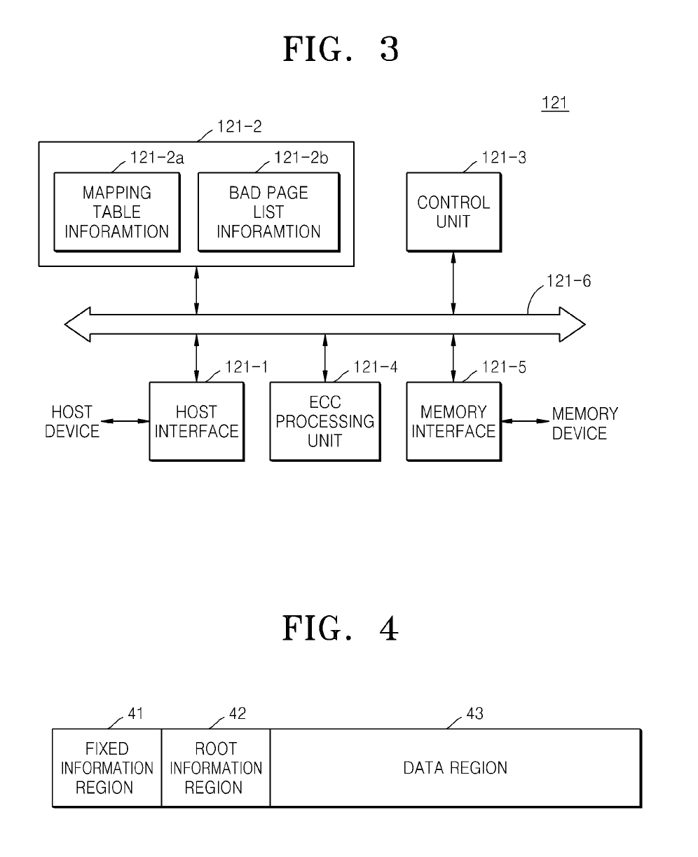

Referring to FIG. 4, the storage region of the memory device 122 may be divided into a fixed information region 41, a root information region 42, and a data region 43.

The fixed information region 41 may store unique information of the memory device 122, e.g., information regarding a file system, a version, and the number of pages in each block. The root information region 42 may store information regarding a location where the metadata is stored. The data region 43 may store the metadata and user data. The data region 43 may be divided into a metadata storage region and a user data region. The user data region may be divided into a data storage region and a spare region, and the spare region may store an ECC.

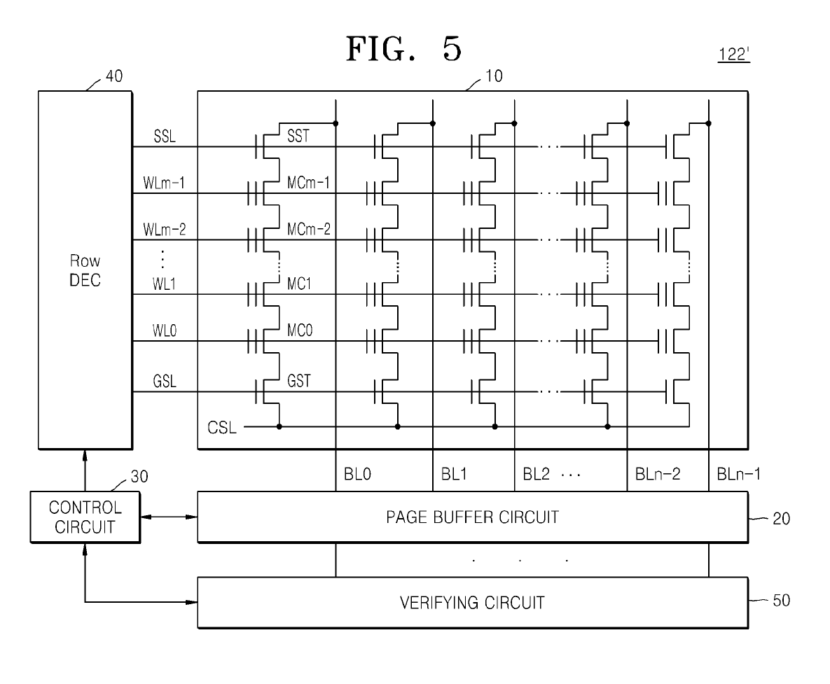

For example, the detailed structure of the memory device 122 implemented using a flash memory 122′ is illustrated in FIG. 5.

Referring to FIG. 5, the flash memory 122′ may include a cell array 10, a page buffer circuit 20, a control circuit 30, a row decoder 40, and a verifying circuit 50.

The cell array 10 may be a region into which data is written by applying a certain voltage to a transistor. The cell array 10 may include memory cells where word lines WL0 through WLm-1 and bit lines BL0 through BLn-1 overlap each other. Here, m and n are natural numbers. Although one memory block is illustrated in FIG. 5, the cell array 10 may include a plurality of memory blocks. Each memory block may include pages corresponding to the word lines WL0 through WLm-1. Each page may include a plurality of memory cells connected to each word line. The flash memory 122′ may perform an erase operation in units of blocks, and performs a program or read operation in units of pages.

The cell array 10 may have a structure of cell strings. Each cell string includes a string selection transistor SST connected to a string selection line SSL, a plurality of memory cells MC0 through MCm-1 respectively connected to the word lines WLO through WLm-1, and a ground selection transistor GST connected to a ground selection line GSL. Here, the string selection transistor SST may be connected between a bit line and a string channel, and the ground selection transistor GST is connected between the string channel and a common source line CSL.

The page buffer circuit 20 may be connected to the cell array 10 via the bit lines BL0 through BLn-1. The page buffer circuit 20 may temporarily store data to be written into memory cells connected to a selected word line or data read from memory cells connected to a selected word line.

The control circuit 30 may generate various voltages required to perform write or read, and erase operations, receives control signals, and controls overall operations of the flash memory 122′.

The row decoder 40 may be connected to the cell array 10 via the string selection line SSL, the ground selection line GSL, and the word lines WL0 through WLm-1. In a write or read operation, the row decoder 40 may receive an address and select any one word line according to the received address. Here, the selected word line may be connected to memory cells on which the write or read operation is to be performed.

Also, the row decoder 40 may apply voltages required to perform a program or read operation (e.g., a program voltage, a pass voltage, a read voltage, a string selection voltage, and a ground selection voltage) to the selected word line, unselected word lines, the string selection line SSL, and the ground selection line GSL.

Each memory cell may store one-bit data or two-or-more-bit data. A memory cell for storing one-bit data is referred to as a single level cell (SLC). A memory cell for storing two-or-more-bit data is referred to as a multi level cell (MLC). An SLC may have an erase or program state according to a threshold voltage.

In particular, as flash memory formed of MLCs may degrade in reliability according to a factor such as a usage time or a program/erase cycle, an ECC correction impossibility state may occur. The physical pages of the flash memory may include spare regions, and ECC information is stored in the spare regions.

The verifying circuit 50 may determine whether selected memory cells have all successfully had a program operation performed thereon, based on data received from the page buffer circuit 20 in a verification operation. When it is determined that the selected memory cells have all successfully had a program operation performed thereon, a pass signal may be output to the control circuit 30. When it is determined that at least one of the selected memory cells have not successfully had a program operation performed thereon, a fail signal may be output to the control circuit 30.

The control circuit 30 may control a program/erase operation in response to the pass or fail signal received from the verifying circuit 50. In response to the pass signal, the control circuit 30 may transmit a signal informing a program success to the memory controller 121 and concludes the program operation. Also, when the fail signal is received after a program loop number reaches a maximum allowable number, the control circuit 30 may transmit a program fail signal to the memory controller 121.

In response to the program fail signal from the control circuit 30 of the flash memory 122′, the memory controller 121 may determine a page having a program fail to be a bad page.

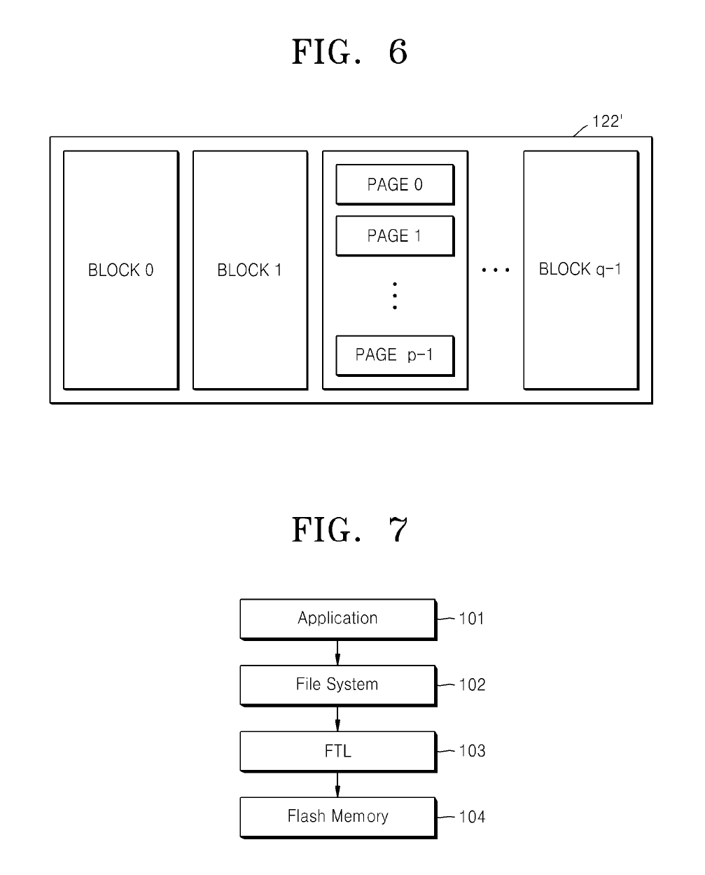

As illustrated in FIG. 6, the storage region of the flash memory 122′ may include a plurality of blocks each including a plurality of pages. For example, each block may include 256 pages. Each page may include 16 sectors.

The flash memory 122′ may write and read data in units of pages, and erase data in units of blocks. Also, an erase operation of a block may be required before a write operation is performed. As such, an overwrite operation may be disabled.

A non-overwritable memory device may not write user data into a user-desired physical region. Accordingly, if access to a region for writing or reading user data is requested by a user, address translation for translating a logical address of the region into a physical address of a physical region in which the user data is currently stored or in which it is to be actually stored may be required.

An operation of translating a logical address into a physical address in the data storage system 1000 will now be described in detail with reference to FIG. 7.

FIG. 7 is a diagram showing a logical hierarchical structure of software of the data storage system 1000 illustrated in FIG. 1. For example, FIG. 7 shows a case when the memory device 122 of the data storage system 1000 is implemented using a flash memory 104.

Referring to FIG. 7, the data storage system 1000 has a software hierarchical structure in an order of an application 101, a file system 102, a flash translation layer (FTL) 103, and the flash memory 104. Here, the flash memory 104 refers to the flash memory 122′ illustrated in FIGS. 5 and 6.

The application 101 refers to firmware for processing user data in response to an input of a user via the UI 110-5. For example, the application 101 may be document processing software such as a word processor, calculation software, or a document viewer such as a web browser. The application 101 may process user data in response to an input of a user, and transmit a command for storing the processed user data in the flash memory 104 to the file system 102.

The file system 102 may refer to a structure or software used to store the user data in the flash memory 104. The file system 102 may allocate a logical address for storing the user data in response to the command transmitted from the application 101. The file system 102 may be, for example, a file allocation table (FAT) file system or a new technology file system (NTFS).

The FTL 103 may translate the logical address received from the file system 102 into a physical address for performing a read/write operation on the flash memory 104. The FTL 103 may translate the logical address into the physical address by using the mapping table information 121-2a. A page mapping method or a block mapping method may be used to perform address mapping. In the page mapping method, address mapping may be performed in units of pages. In the block mapping method, address mapping may be performed in units of blocks. A hybrid mapping method corresponding to a combination of the page mapping method and the block mapping method may also be used to perform address mapping. The physical address may refer to a location of the flash memory 104 in which data is stored.

The FTL 103 may perform a mapping process so that the pages registered in the bad page list information 121-2b are excluded from a storage region where data is to be programmed. The FTL 103 may also perform a mapping process so that remaining pages excluding the pages registered in the bad page list information 121-2b from a data block are reused as a storage region in a garbage collection operation.

In detail, the FTL 103 may perform address translation according to the following operations by using the firmware built in the control unit 121-3 of FIG. 3.

First, an address translation process in response to a data write request will be described.

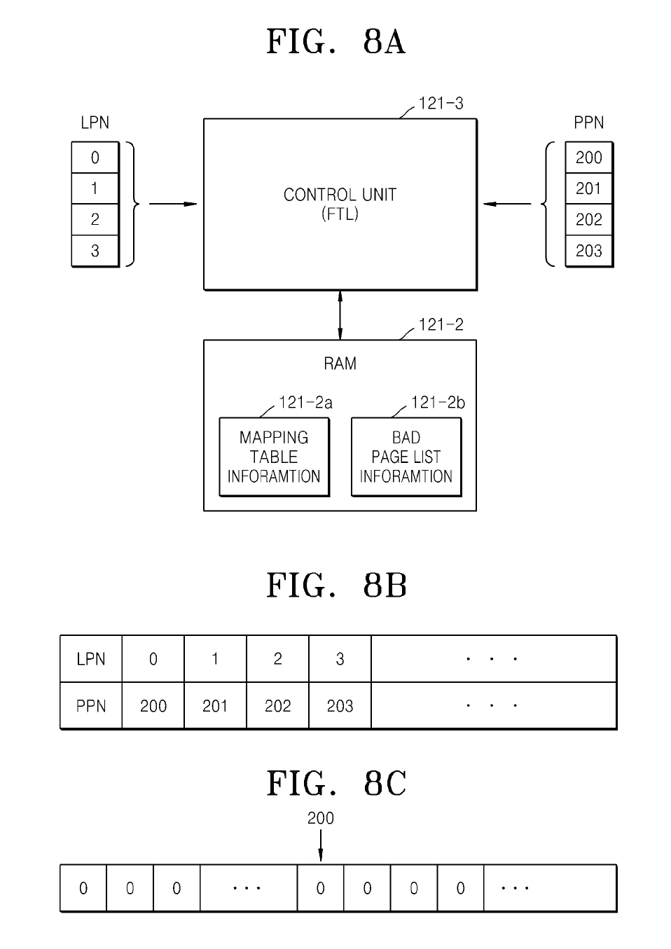

FIG. 8A is a block diagram for showing an address translation process in an FTL in response to a data write request according to example embodiments of the inventive concepts.

Referring to FIG. 8A, when a write request with respect to logical page numbers (LPNs) 0-3 is made according to a write command, the control unit 121-3 may allocate physical page numbers (PPNs) 200-203 by using the mapping table information 121-2a and the bad page list information 121-2b stored in the RAM 121-2. The allocated PPNs 200-203 may be selected from PPNs that are not allocated to LPNs in the mapping table information 121-2a and that are not registered in the bad page list information 121-2b.

After a data program operation in response to a write request is successfully completed in a storage region of the flash memory 122′ that is indicated by the allocated PPNs 200-203, the mapping table information 121-2a may be updated so that the PPNs 200-203 are mapped to the LPNs 0-3 in the mapping table information 121-2a, as shown in FIG. 8B. As shown in FIG. 8C, in the bad page list information 121-2b, ‘0’ may be written to indicate that the PPNs 200-203 are normal pages.

Next, an address translation process when a bad page is detected during a program operation in response to a data write request will be described.

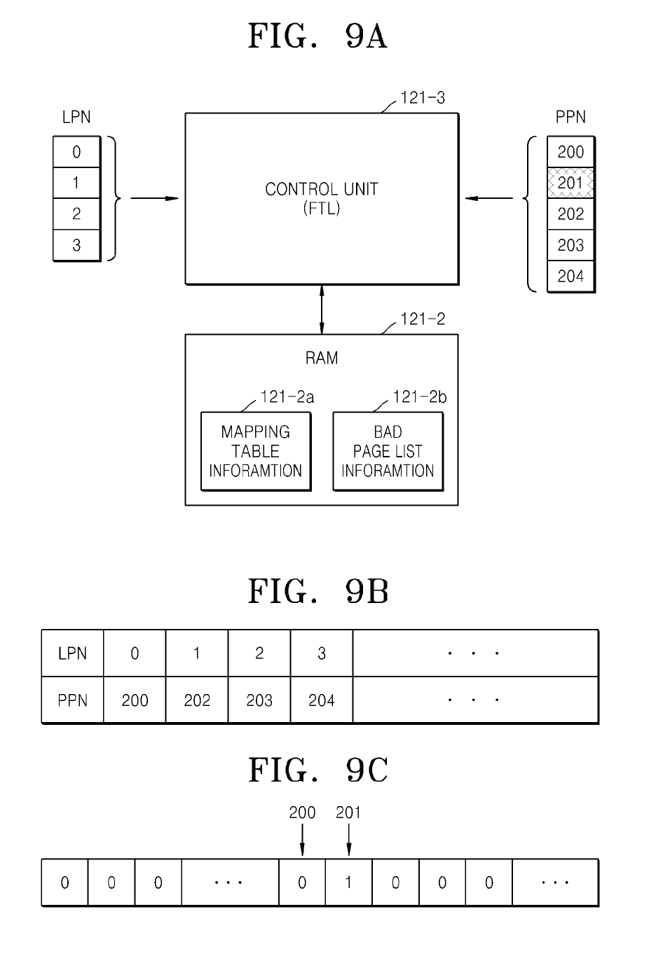

FIG. 9A is a block diagram for showing an address translation process in an FTL in response to a data write request according to example embodiments of the inventive concepts.

Referring to FIG. 9A, when a write request with respect to LPNs 0-3 is made according to a write command, the control unit 121-3 may allocate PPNs 200-203 by using the mapping table information 121-2a and the bad page list information 121-2b stored in the RAM 121-2. The allocated PPNs 200-203 may be selected from PPNs that are not allocated to LPNs in the mapping table information 121-2a and that are not registered in the bad page list information 121-2b.

In a data program operation in response to a write request performed on a storage region of the flash memory 122′ that is indicated by the allocated PPNs 200-203, when the PPN 201 fails in the data program operation, data of the LPN 1 may be programmed to be stored in the PPN 202 instead of the PPN 201, and pieces of data of the LPNs 2 and 3 may be programmed to be stored in the PPNs 203 and 204, respectively. After the data program operation is successfully completed in the PPNs 200, 202, 203, and 204, the mapping table information 121-2a is updated so that the PPNs 200, 202, 203, and 204 are mapped to the LPNs 0˜3 in the mapping table information 121-2a, as shown in FIG. 9B.

As shown in FIG. 9C, ‘1’ is written to the PPN 201 to register the PPN 201 as a bad page in the bad page list information 121-2b. Accordingly, the PPN 201 may be excluded from the storage region of the flash memory 122′ where data is to be programmed. The PPNs 200, 202, 203, and 204 included in the same block as the block in which the PPN 201 is included may be normally accessed. For example, when a garbage collection operation is performed on a data block including the PPNs 200-204, the PPNs 200, 202, 203, and 204 may be allowed to be reused as the storage region to which data is to be programmed.

Next, an address translation process when a bad page is detected during a read operation in response to a data read request will be described.

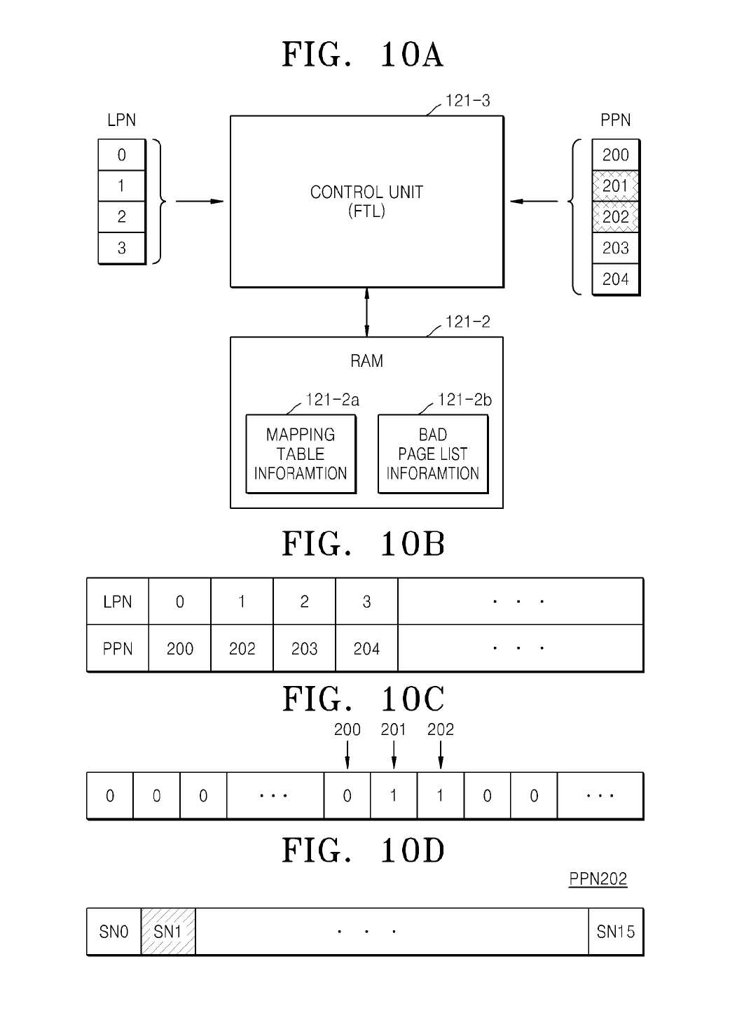

It is assumed that the mapping table information 121-2a is constructed as shown in FIG. 10B. FIG. 10A shows an address translation process in an FTL when a data read request with respect to LPNs 0-3 is made.

Referring to FIG. 10A, when a read request with respect to the LPNs 0-3 is made according to a read command, the control unit 121-3 may translate the LPNs 0-3 into PPNs 200, 202, 203, and 204 by using the mapping table information 121-2a stored in the RAM 121-2.

In a data read operation in response to a read request performed on a storage region of the flash memory 122′ that is indicated by the translated PPNs 200, 202, 203, and 204, when the PPN 202 fails in the data read operation, the PPN 202 is registered in the bad page list information 121-2b. In other words, as shown in FIG. 10C, ‘1’ is written to the PPN 202 to register the PPN 202 as a bad page in the bad page list information 121-2b. The mapping table information 121-2a maintains a state in which the PPN 202 is mapped to the LPN 1.

For reference, each page includes a plurality of sectors. For example, each page may include 16 sectors. When a read operation on one of the sectors included in a page fails, the page is registered in the bad page list information 121-2b. For example, as shown in FIG. 10D, even when a read operation on a sector SN1 of sectors SN0-SN15 constituting the PPN 202 fails, the mapping table information 121-2a may maintain a state in which the PPN 202 is mapped to the LPN 1, to enable a data read operation to be performed on the remaining sectors SN0 and SN2-SN15.

However, mapping may be performed so that the pages registered in the bad page list information 121-2b from a data block are excluded from the storage region to which data is to be programmed in a garbage collection operation. Mapping is also performed so that remaining pages excluding the pages registered in the bad page list information 121-2b from the data block are allowed to be reused as the storage region.

When the number of free blocks is smaller than a first threshold value TH1 which is initially set, the control unit 121-3 may select a victim block from data blocks to generate a free block. The control unit 121-3 may perform a garbage collection operation by storing an effective page of the victim block in an active block. The garbage collection operation will now be described in detail.

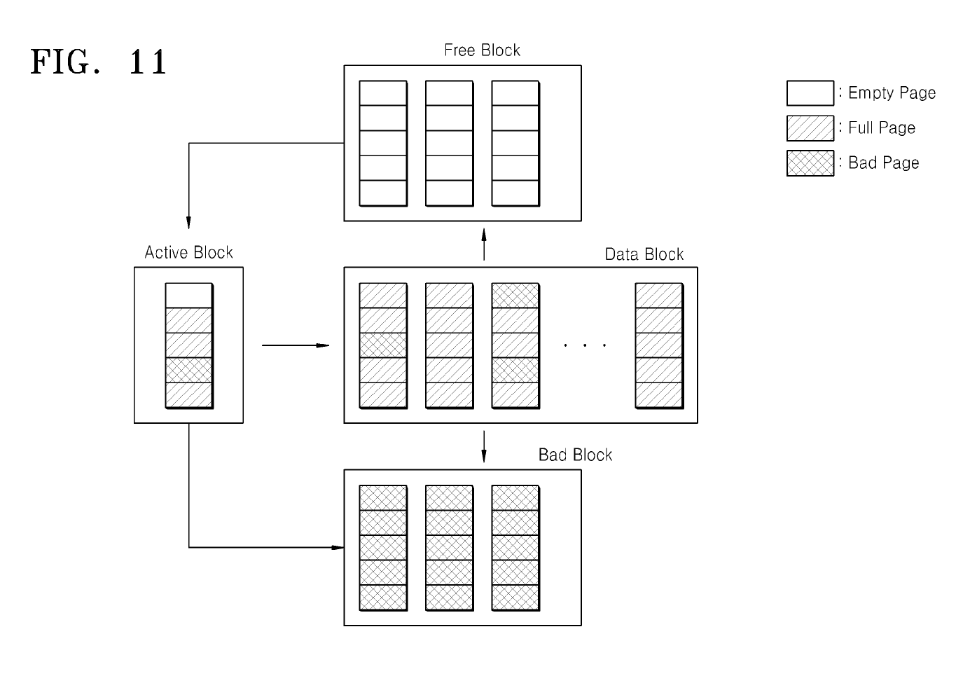

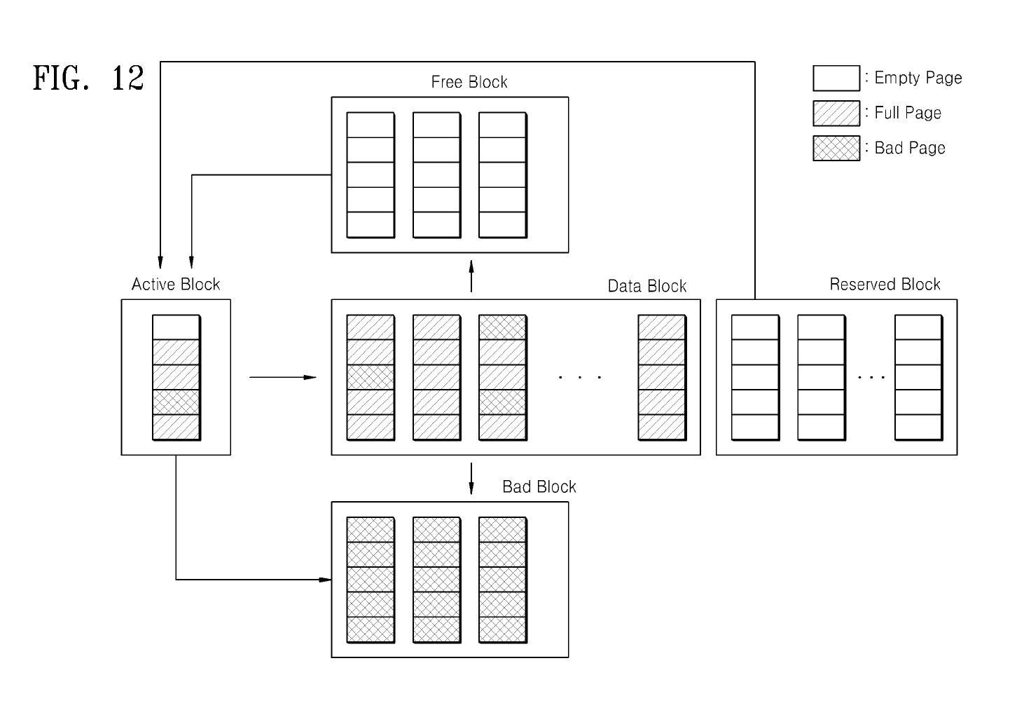

A mapping process flow according to a bad storage region managing method of a memory device according to example embodiments of the inventive concepts, which is performed using the firmware built in the control unit 121-3, will now be described with reference to FIGS. 11 and 12. Although each block includes 5 pages in FIGS. 11 and 12 for convenience of explanation, the number of pages included in each block is not limited thereto. For example, as described above, each block may include 256 pages. The number of pages included in each block may vary.

FIG. 11 is a diagram for showing a relationship among blocks according to a mapping process to which the bad storage region managing method in the flash memory 122′ is applied.

For example, as shown in FIG. 11, the storage region of the flash memory 122′ may be divided into a free block, an active block, a data block, and a bad block. The free block represents a block having no data stored therein, the active block is a block having data stored therein and represents a memory block having pages to which data can be written, and the data block is a block having data stored therein and represents a block in which no data-writable pages are left therein. In other words, the data block does not have empty pages to which data can be written. The bad block is a block unable to be used as a data storage region. For example, when all of the pages included in a block fail in a program, read, or erase operation, the block may be designated as a bad block.

In response to a data write request, an FTL according to example embodiments of the inventive concepts may allocate an LPN requested for writing to an empty page included in an active block. At this time, the FTL may select the empty page from PPNs not registered in the bad page list information 121-2b from among empty pages included in the active block. When the active block has no more empty pages, the active block is classified into the data block and a new free block is classified into the active block.

Pages having program fails in an active block during a data program operation in response to a write request are registered in the bad page list information 121-2b, and a data program operation may be performed by allocating the other physical pages existing in the active block to logical pages for the write request. When a data program operation is succeeded, mapping information of a physical page with respect to a logical page on which the data program operation has been performed may be updated in a mapping table.

When all of the pages included in a block have program fails during a data program operation in response to a write request, the block may be classified into the data block and a new free block is classified into the active block.

Next, when a page having a read fail is detected in a data read operation in response to a read request, the page is registered in the bad page list information 121-2b.

When the number of free blocks is smaller than the first threshold value TH1, a victim block may be selected from the data block to generate a free block according to a garbage collection operation. At this time, mapping may be performed to prohibit the pages registered in the bad page list information 121-2b from among the pages included in a data block selected as the victim block from being reused as a storage region and to allow the pages not registered in the bad page list information 121-2b to be reused as a storage region.

When all of the pages included in the data block selected as a victim block are registered in the bad page list information 121-2b, a garbage collection operation may be performed by classifying the data block into a bad block and selecting a new data block as a victim block.

For example, as shown in FIG. 12, the storage region of the flash memory 122′ may be divided into a free block, an active block, a data block, a reserved block, and a bad block.

In contrast with the storage region of the flash memory 122′ of FIG. 11, the reserved block is further included and represents memory blocks for replacing generated bad blocks.

In FIG. 11, when all of the pages included in a data block are bad pages, the data block may be classified into a bad block and the bad block may be replaced with a free block. However, in FIG. 12, when a bad block is generated, the reserved block may be used as a replacement of the bad block.

The other operations of the bad storage region managing method of the memory device 122′ may be the same as described above with reference to FIG. 11, so a description thereof will be omitted here.

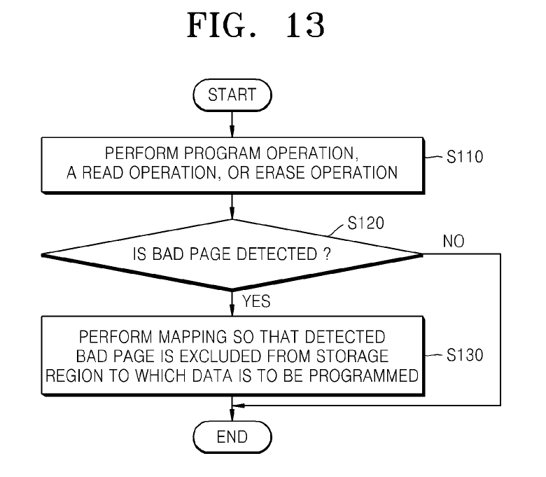

A method of managing a bad storage region of a memory device according to example embodiments of the inventive concepts will now be described with reference to a flowchart of FIG. 13. For reference, the method of the flowchart of FIG. 13 may be performed under the control of the control unit 121-3 of FIG. 3.

First, in operation S110, the control unit 121-3 may perform one of a program operation, a read operation, and an erase operation on the memory device 122 according to a received command.

Next, in operation S120, the control unit 121-3 may determine whether a bad page that has failed in one of the program operation, the read operation, and the erase operation is detected.

For example, a bad page in a program operation may be detected by determining a page having a program fail signal to be a bad page by using the verifying circuit 50 and the control circuit 30 of the flash memory 122′ of FIG. 5. For example, a bad page in a read operation may be detected by determining a page generating a read fail signal to be a bad page in the ECC processing unit 121-4 of the memory controller 121 of FIG. 3.

Next, in operation S130, the control unit 121-3 may perform mapping so that the detected bad page is excluded from a storage region to which data is to be programmed. For example, the control unit 121-3 may perform mapping so that the detected bad page is registered in the bad page list information 121-2b and so that remaining pages excluding the bad page registered in the bad page list information 121-2b from a data block are allowed to be reused as a storage region in a garbage collection operation.

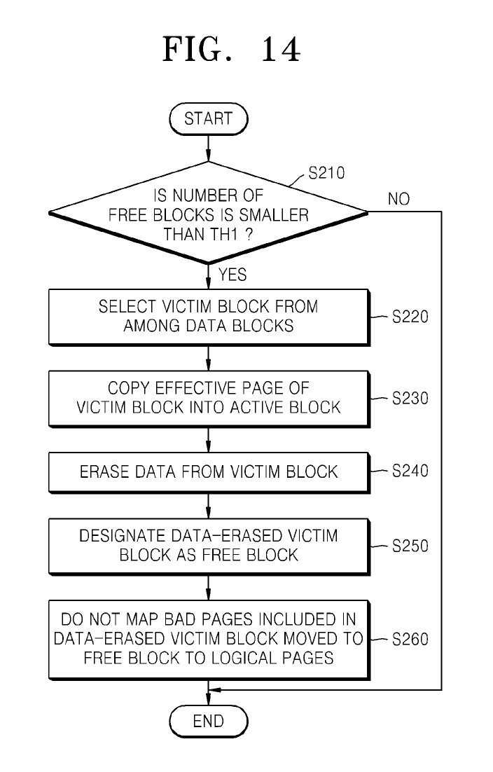

Next, a garbage collection method based on bad storage region management of a memory device according to example embodiments of the inventive concepts will now be described with reference to a flowchart of FIG. 14. For reference, the method of the flowchart of FIG. 14 may be performed under the control of the control unit 121-3 of FIG. 3.

In operation S210, the control unit 121-3 may determine whether the number of free blocks is smaller than the first threshold value TH1 which is initially set.

When it is determined in operation S210 that the number of free blocks is smaller than the first threshold value TH1, the control unit 121-3 may select a victim block from among data blocks, in operation S220. For example, a data block having the smallest garbage collection cost may be selected as a victim block. For example, a data block having a largest number of ineffective pages from among data blocks may be selected as a victim block for a garbage collection process.

In operation S230, the control unit 121-3 may copy an effective page of the victim block into an empty page of an active block. At this time, the control unit 121-3 may perform mapping so that the effective page of the victim block is not copied into pages registered in the bad page list information 121-2b from among the empty pages of the active block.

Next, in operation S240, the control unit 121-3 may erase data from the victim block.

Next, in operation S250, the control unit 121-3 designates the data-erased victim block as a free block.

Next, in operation S260, the control unit 121-3 performs a process so that bad pages included in the data-erased victim block moved to the free block are not mapped to logical pages according to a garbage collection operation.

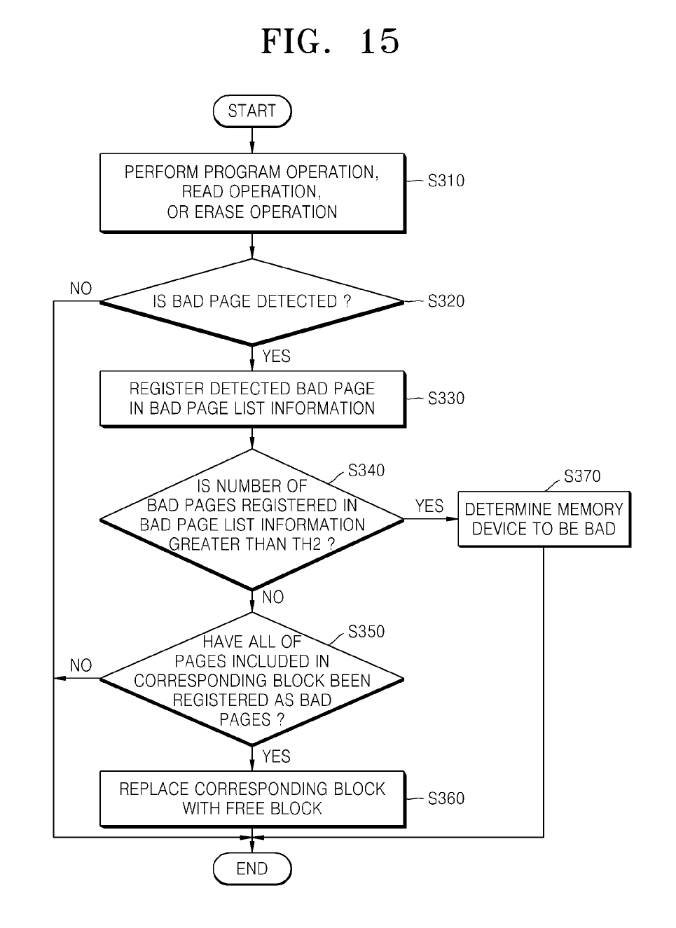

A method of managing a bad storage region of a memory device according to example embodiments of the inventive concepts will now be described with reference to a flowchart of FIG. 15. For reference, the method of the flowchart of FIG. 15 may be performed under the control of the control unit 121-3 of FIG. 3.

First, in operation S310, the control unit 121-3 may perform one of a program operation, a read operation, and an erase operation on the memory device 122 according to a received command.

Next, in operation S320, the control unit 121-3 may determine whether a bad page that has failed in one of the program operation, the read operation, and the erase operation is detected.

Next, in operation S330, the control unit 121-3 may register the detected bad page in the bad page list information 121-2b.

Next, in operation S340, the control unit 121-3 may determine whether the number of bad pages registered in the bad page list information 121-2b is greater than a second threshold value TH2 which is initially set. The second threshold value TH2 may be determined based on a memory capacity standard of the memory device 122. For example, a second threshold value TH2, which satisfies the condition that the capacity of a storage region excluding a storage region for bad pages from the entire storage region of the memory device 122 is greater than the memory capacity standard of the memory device 122, may be determined.

When it is determined in operation S340 that the number of bad pages registered in the bad page list information 121-2b is not greater than the second threshold value TH2, the control unit 121-3 may determine whether all of the pages included in a corresponding block have been registered as bad pages, in operation S350.

When it is determined in operation S350 that all of the pages included in a corresponding block have been registered as bad pages, mapping may be performed to replace the corresponding block with a free block, in operation S360.

When it is determined in operation S340 that the number of bad pages registered in the bad page list information 121-2b is greater than the second threshold value TH2, the control unit 121-3 may determine the memory device 122 to be bad, in operation S370. When the memory device 122 is determined to be bad, data may be prevented from being written to the memory device 122.

When it is determined in operation S320 that no bad pages are detected or it is determined in operation S350 that none of the pages included in a corresponding block are registered as a bad page, the method is concluded.

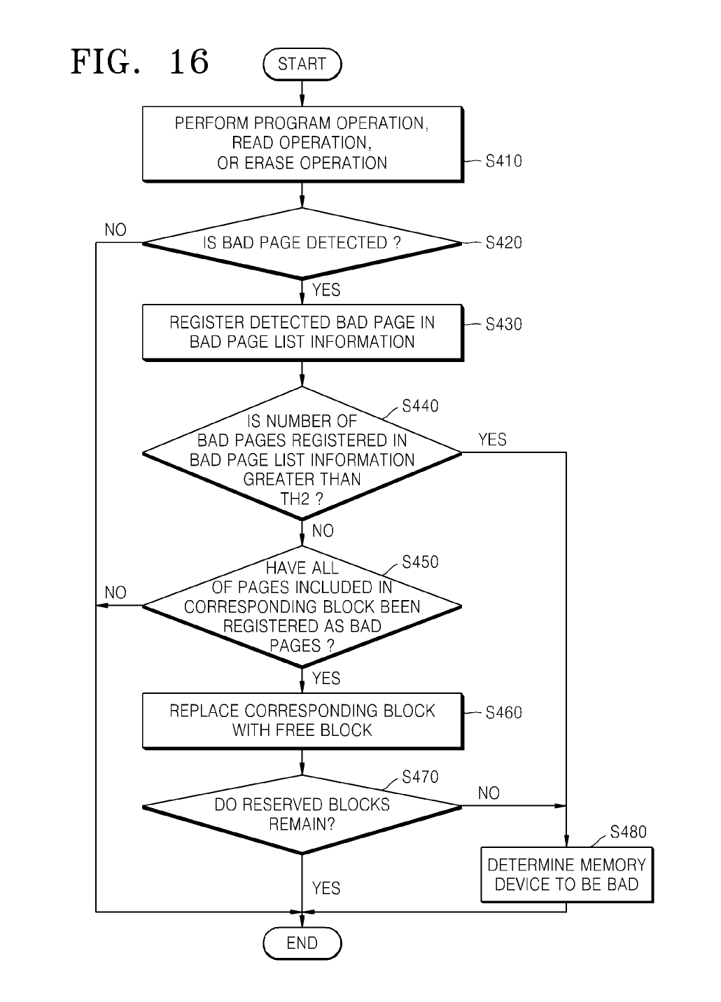

A method of managing a bad storage region of a memory device according to example embodiments of the inventive concepts will now be described with reference to a flowchart of FIG. 16. For reference, the method of the flowchart of FIG. 16 may be performed under the control of the control unit 121-3 of FIG. 3.

First, in operation S410, the control unit 121-3 may perform one of a program operation, a read operation, and an erase operation on the memory device 122 according to a received command.

Next, in operation S420, the control unit 121-3 may determine whether a bad page that has failed in one of the program operation, the read operation, and the erase operation is detected.

Next, in operation S430, the control unit 121-3 may registers a detected bad page in the bad page list information 121-2b.

Next, in operation S440, the control unit 121-3 may determine whether the number of bad pages registered in the bad page list information 121-2b is greater than a second threshold value TH2 which is initially set.

When it is determined in operation S440 that the number of bad pages registered in the bad page list information 121-2b is not greater than the second threshold value TH2, the control unit 121-3 may determine whether all of the pages included in a corresponding block have been registered as bad pages, in operation S450.

When it is determined in operation S450 that all of the pages included in a corresponding block have been registered as bad pages, mapping may be performed to replace the corresponding block with a reserved block, in operation S460.

Next, in operation S470, the control unit 121-3 may determine whether reserved blocks remain in the memory device 122.

When it is determined in operation S470 that no reserved blocks remain or it is determined in operation S440 that the number of bad pages registered in the bad page list information 121-2b is greater than the second threshold value TH2, the control unit 121-3 may determine the memory device 122 to be bad, in operation S480.

When it is determined in operation S420 that no bad pages are detected or it is determined in operation S450 that none of the pages included in a corresponding block have been registered as a bad page, the method is concluded.

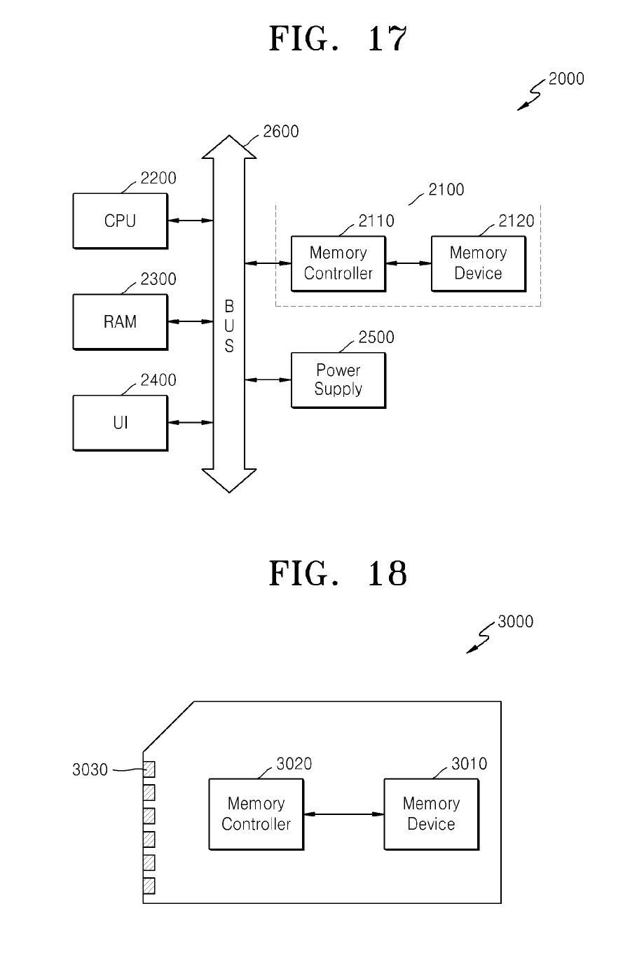

FIG. 17 is a block diagram of a computer system 2000 according to example embodiments of the inventive concepts.

Referring to FIG. 17, the computer system 2000 may include a central processing unit (CPU) 2200, a RAM 2300, a UI 2400, and a storage device 2100 electrically connected via a bus 2600. The storage device 2100 may include a memory controller 2110 and a memory device 2120. The memory device 2120 may store via the memory controller 2110 data processed or to be processed by the CPU 2200. The storage device 2100 may be implemented using the storage device 120 illustrated in FIG. 1. The computer system 1000 may further include a power supply 2500.

If the computer system 2000 is a mobile device, the power supply 2500 of the computer system 2000 may be a battery and the computer system 2000 may additionally include a modem such as a baseband chipset. Since it is apparent to one of ordinary skill in the art that an application chipset, a camera image processor (CIS), a mobile DRAM, or the like may be further included in the computer system 2000 according to the present embodiment, a detailed description thereof will be omitted.

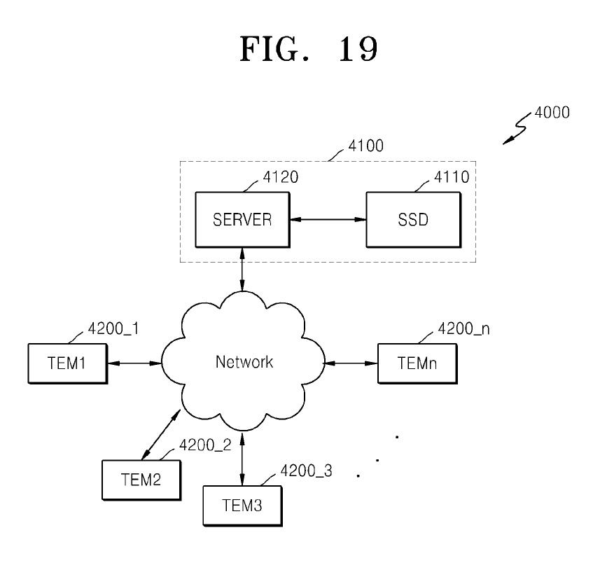

FIG. 18 is a block diagram of a memory card 3000 according to example embodiments of the inventive concepts.

Referring to FIG. 18, the memory card 3000 may include a memory controller 3020 and a memory device 3010. The memory controller 3020 may control a write or read operation of data into or from the memory device 3010 in response to a request of an external host received via an input/output (I/O) unit 3030. For this, the memory controller 3020 of the memory card 3000 may include, for example, an interface for interfacing between the host and the memory device 3010, and RAM. The memory card 3000 may be implemented using the storage device 120 illustrated in FIG. 1.

The memory card 3000 may be implemented using a compact flash card (CFC), a micro drive, a smart media card (SMC), a multimedia card (MMC), a security digital card (SDC), a memory stick, a USB flash memory driver, or the like.

FIG. 19 is a block diagram of a network system 4000 and a server system 4100 including an SSD 4110, according to example embodiments of the inventive concepts.

Referring to FIG. 19, the network system 4000 may include the server system 4100 and a plurality of terminals 4200_1 through 4200_{—}n connected in a network. The server system 4100 may include a server 4120 for processing requests received from the terminals 4200_1 through 4200_{—}n connected in the network, and the SSD 4110 for storing data corresponding to the requests received from the terminals 4200_1 through 4200_{—}n. In this case, the SSD 4110 may be implemented using the storage device 120 illustrated in FIG. 1.

Meanwhile, the data storage system 1000 illustrated in FIG. 1 may be mounted by using various types of packages including, for example, a package on package (POP), a ball grid array (BGA), a chip scale package (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small-outline integrated circuit (SOIC), a shrink small outline package (SSOP), a thin small outline package (TSOP), a system in package (SIP), a multi chip package (MCP), a wafer-level fabricated package (WFP), and a wafer-level processed stack package (WSP).

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A method of managing a bad storage region of a memory device, the method comprising:
detecting a bad page of a selected data block that has failed in one of a program operation, a read operation, and an erase operation on the memory device; and
performing a mapping process so that the detected bad page is excluded from a storage region to which data is to be programmed, wherein remaining pages of the selected data block excluding the bad page are allowed to be used as a storage region in a garbage collection operation.

2. The method of claim 1, wherein the performing of the mapping process comprises:
registering the bad page in bad page list information and excluding pages registered in the bad page list information from a storage region to which data is to be stored.

3. The method of claim 1, wherein if the bad page is detected in the program operation, the performing of the mapping process comprises::
registering storage region information regarding the bad page in bad page list information; and
allocating a physical address for a logical address corresponding to first data to be programmed into the bad page so the first data is programmed into a page not registered in the bad page list information.

4. The method of claim 3, wherein, if an empty page not registered in the bad page list information exists in the data block including the bad page, a physical address is allocated for the logical address so the first data is programmed into one of empty pages of the data block, and, when no empty pages exist in the data block including the bad page, a physical address is allocated for the logical address so that the first data is programmed into one of pages included in a new free block.

5. The method of claim 3, wherein information of the storage region is represented by a physical page number.

6. The method of claim 3, further comprising:
determining the memory device to be bad when a number of bad pages registered in the bad page list information exceeds a threshold value.

7. The method of claim 3, wherein, when all of pages included in the selected data block to which data is to be programmed are detected as bad pages in the program operation, mapping is performed so that the selected data block is replaced with a new free block.

8. The method of claim 3, wherein, when all of pages included in the selected data block to which data is to be programmed are detected as bad pages in the program operation, mapping is performed so that the selected data block is replaced with a reserved block.

9. The method of claim 1, wherein if the bad page is detected in the read operation, the performing of the mapping process comprises:
registering storage region information regarding the bad page into bad page list information; and
performing a mapping process so that the bad page is not reused as part of the storage region in the garbage collection operation.

10. The method of claim 9, further comprising:
determining the memory device to be bad when the number of bad pages registered in the bad page list information exceeds a threshold value.

11. The method of claim 9, wherein, when all of pages included in the selected data block from which data is to be read are detected as bad pages in the read operation, mapping is performed so that the selected data block from which data is to be read is replaced with a reserved block.

12. The method of claim 9, wherein, when all of pages included in the selected data block from which data is to be read are detected as bad pages in the read operation, mapping is performed so that the selected data block from which data is to be read is replaced with a new free block.

13. A storage device comprising:
a memory device configured to store data; and
a memory controller configured to perform mapping so that a bad page of a selected data block for which a program fail, a read fail, or an erase fail occurred in the memory device is excluded from a storage region to which data is to be programmed, and so that remaining pages of the selected data block excluding the bad page are reused as the storage region in a garbage collection operation.

14. The storage device of claim 13, wherein the memory device comprises:
an array of memory cells which includes a plurality of pages;
a page buffer circuit configured to program the memory cells or read data from the memory cells;
a verifying circuit configured to perform program verification or erase verification on the memory cells in response to program data received from the page buffer circuit; and
a control circuit configured to control a program operation or an erase operation based on a result of the program verification or a result of the erase verification.

15. The storage device of claim 13, wherein the memory controller comprises:
a volatile memory unit configured to temporarily store mapping table information and bad page list information; and
a control unit configured to perform mapping such that the bad page for which a program fail, a read fail, or an erase fail occurred in the memory device is registered in a bad page list information, pages registered in the bad page list information are excluded from pages which are to be mapped to logical addresses designated by a program command, and pages not registered in the bad page list information are reused as the storage region in a garbage collection operation.

16. A method of managing a memory device, the method comprising:
identifying one or more bad pages for which a failed memory access operation occurred in the memory device from among a plurality of pages of a data block;
allocating space within the data block by designating only data pages, from among the plurality of data pages, which have not been identified as one of the one or more bad pages as free pages available to store data.

17. The method of claim 16, further comprising:
storing an indication of the one or more bad pages in a bad page list.

18. The method of claim 17, wherein the allocating includes, during a garbage collection operation, checking the bad page list, and designating only pages, from among the plurality of pages, which are not included on the bad page list as free pages available for storing data.

19. The method of claim 17, further comprising:
mapping one or more logical addresses of first data to be stored in the data block only to one or more physical addresses corresponding to pages, from among the plurality of pages, which are not included on the bad page list.
